(19) United States
(12) Patent Application Publication
(10) Pub. No.: US 2017/0373349 A1
(43) Pub. Date: Dec. 28, 2017

(54) NITRILES AND AMINES AS ELECTROLYTE COMPONENTS FOR LITHIUM-ION BATTERIES

(71) Applicant: Wacker Chemie AG, Munich (DE)

(72) Inventors: Daniel BRAEUNLING, Munich (DE); Frank DEUBEL, Munich (DE); Margit KRATZL, Hetzenhausen (DE)

(73) Assignee: Wacker Chemie AG, Munich (DE)

(21) Appl. No.: 15/527,109

(22) PCT Filed: Sep. 8, 2016
(86) PCT No.: PCT/EP2016/071154

§ 371 Date: May 16, 2017

(30) Foreign Application Priority Data
Sep. 28, 2015 (DE) 10 2015 218 634.2

(51) Int. Cl. H01M 10/0568; H01M 4/133; H01G 11/62; C07F 7/18; C07F 7/12; H01M 10/0525; C07F 7/08

(52) U.S. Cl. CPC H01M 10/0568; H01M 10/0525; H01M 4/133; C07F 7/0818; C07F 7/184; C07F 7/12; H01G 11/62

(57) ABSTRACT

An electrolyte containing vinylene carbonate, an amine, a nitrile, and a conductive lithium salt is useful in lithium ion batteries to improve discharge retention after multiple charge/discharge cycles.

### CROSS REFERENCE TO RELATED APPLICATIONS

This application is the U.S. National Phase of PCT Appln. No. PCT/EP2016/071154 filed Sep. 8, 2016, which claims priority to German Application No. 10 2015 218 634.2 filed Sep. 28, 2015, the disclosures of which are incorporated in their entirety by reference herein.

### BACKGROUND OF THE INVENTION

### Field of the Invention

The invention relates to an electrolyte which comprises aprotic solvent, lithium-containing conducting salt, vinylene carbonate, nitrile and amine, and also to a lithium-ion battery.

### Description of the Related Art

Lithium-ion batteries are among the most promising systems for mobile applications. The fields of use range from high-value electronic equipment through to batteries for electrically driven motor vehicles.

Stock electrolyte solutions for lithium-ion batteries based on cyclic/aliphatic carbonates have been widely described and, as main components, form the basis of the majority of base electrolyte compositions. Vinylene carbonate (VC), which as a film-forming additive is intended to support the construction of the solid electrolyte interface (SEI), is typically added in amounts of 2-10 wt %. U.S. Pat. No. 7,476,469 also describes stock solutions having a higher VC fraction for an anode material consisting of thin amorphous/microcrystalline silicon layers.

Gu-Yeon Kim and J.R. Dahn, Journal of The Electrochemical Society, 162 (3) A437-A447 (2015) describe the use of certain nitriles (succinonitrile SN, adiponitrile AN, and pimelonitrile PN) as electrolyte additives for NMC442//graphite full cells. An improvement in the capacity loss in conjunction with a minimization of formation of gas in cycling experiments at 60° C. is described. Following addition of SN, moreover, improved electrolyte oxidation stability is observed. This results, consequently, in an improvement in the cycling stability with NMC442 cathode material (>4.4V).

DE10027626 describes, in relation to the prior art, tributylamine as electrolyte additive for the scavenging of H₂O and HF. Tributylamine is not oxidation-stable and is decomposed irreversibly at about 3.5 V versus Li/Li⁺.

Tributylamine as an electrolyte additive contributes to improving the storage stability of the cell by stabilizing the conducting salt LiPF₆, as described in DE69027143.

U.S. Pat. No. 8,551,661 uses substituted/unsubstituted amines, such as trialkylamines, arylamines and heterocyclic amines, as a first possible additive, in combination with Li(C₂O₄)BF₂ as second additive. This additive combination, used in carbonate-based electrolyte mixtures, exhibited enhanced cycling stabilities and improvements in calendrical ageing.

On account of severe expansion in volume of Si-containing anode materials during cycling, the cycling stability of Li-ion batteries containing Si-containing anode materials is still inadequate. The SEI layer which is formed in the initial cycles as a result of electrochemical decomposition of individual electrolyte constituents does not withstand the severe mechanical loads. Progressive reformation of the SEI layer leads to the depletion/consumption of individual electrolyte constituents and hence to a continuous decrease in the capacity of the cell as the number of cycles goes up.

### SUMMARY OF THE INVENTION

A subject of the invention is an electrolyte which comprises
100 parts by weight of aprotic solvent,
1 to 50 parts by weight of lithium-containing conducting salt,
5 to 100 parts by weight of vinylene carbonate,
0.5 to 20 parts by weight of nitrile, and 0.1 to 10 parts by weight of amine.

### DETAILED DESCRIPTION OF THE PREFERRED EMBODIMENTS

It has been surprisingly found that the capacity retention of lithium-ion batteries during cycling can be improved significantly through the use of a combination of nitriles and amines as an additive in VC-rich stock electrolyte solutions. The continuous retention of capacity is in fact better than for the selected reference electrolyte mixture, starting from electrolyte compositions known from the literature for Si-containing anodes [Kawashima, A. et al., Journal of The Electrochemical Society 2011, 158, A798-A801; Aurbach, D. et al., Langmuir 2012, 28, 965-976]. The reference electrolyte mixture consists of ethyl methyl carbonate (EMC) and fluoroethylene carbonate (FEC) with a small fraction of VC.

Nitriles used with preference are the nitriles of monocarboxylic or polycarboxylic acids which preferably contain 2 to 20 carbon atoms, more preferably 4 to 12 carbon atoms.

Preferred are the nitriles of the aliphatic, saturated monocarboxylic acids such as acetic, propionic, butyric, valeric and caproic acids, and of the fatty acids having up to 18 carbon atoms, more preferably valeronitrile (VN).

Also preferred are the dinitriles of the aliphatic, saturated dicarboxylic acids, such as malonic, succinic, glutaric, adipic, pimelic and suberic acids.

Also preferred are silylated nitriles of the aliphatic, saturated monocarboxylic acids having up to 18 carbon atoms, more preferably 3-(fluorodimethylsilyl)butanenitrile (FSN), which is known from U.S. 20140356735.

Preferred nitriles are those having a boiling point of at least 120° C. at 1013 hPa, more preferably at least 150° C. at 1013 hPa.

The electrolyte preferably comprises 1 to 10 parts by weight, more preferably 2 to 8 parts by weight, of nitrile.

The amines are preferably selected from primary, secondary and tertiary aliphatic and aromatic amines. It is possible to employ monoamines, and also polyamines which have primary, secondary and tertiary amine functions.

Preferred monoamines have the general formula (I)

NR¹R²R³ (I),

in which

R¹, R² and R³ are H or monovalent hydrocarbyl radicals having 1-30 carbon atoms, which may be substituted by substituents selected from F—, Cl— and OR⁴, wherein nonadjacent —CH₂— units may be replaced by units selected from —C(═O)—and —O—, and

R⁴ is alkyl having 1-10 carbon atoms.

The monovalent hydrocarbyl radicals R¹, R² and R³ may be linear, cyclic, branched, aromatic, saturated or unsaturated. The hydrocarbyl radicals R¹, R² and R³ preferably have 1 to 20 carbon atoms, particular preference being given to alkyl radicals having 1 to 6 carbon atoms, alkaryl radicals, arylalkyl radicals, and phenyl radicals.

If two or three of R¹, R² and R³ are joined to one another, they may form a monocyclic or bicyclic hydrocarbon ring.

Preference is given to the tertiary amines wherein, in the general formal (I) R¹, R² and R³ are monovalent, more preferably unsubstituted, hydrocarbyl radicals having 1-30, preferably 2 to 10 carbon atoms.

Preferred polyamines have the general formula (II)

R⁵₂N—(CR⁶₂)ₐ—(NR⁷—(CR⁶₂)_{b})_{c}—NR⁵₂ (II)

in which

R⁵, R⁶ and R⁷ are H or hydrocarbyl radicals having 1-18 carbon atoms, which may be substituted by substituents selected from F—, Cl— and OH—, and wherein nonadjacent —CH₂— units may be replaced by units selected from —C(═0)— and —O—,

a and b are integral values from 1 to 6 and

c has a value of 0 or an integral value from 1 to 40.

a and b are preferably 2 or 3.

c is preferably an integral value from 1 to 6.

Preferably a and b are the same.

Examples of particularly preferred polyamines (A) of the general formula (II) are as follows:
Diethylenetriamine (H₂N—CH₂CH₂—NH—CH₂CH₂—NH₂)
Triethylenetetramine (H₂N—CH₂CH₂—(NH—CH₂CH₂—)₂—NH₂)
Tetraethylenepentamine (H₂N—CH₂CH₂—(NH—CH₂CH₂—)₃—NH₂)
Pentaethylenehexamine (H₂N—CH₂CH₂—(NH—CH₂CH₂—)₄—NH₂)
Hexaethyleneheptamine (H₂N—CH₂CH₂—(NH—CH₂CH₂—)₅—NH₂)
Mixtures of the above amines, of the kind available commercially as technical products, are, for example, AMIX1000® (BASF SE).

Examples of other preferred monoamines and polyamines are octylamine, nonylamine, decylamine, undecylamine, dodecylamine (laurylamine), tributylamine, triisooctylamine, tridecylamine, tridecylamine (isomer mixture), tetradecylamine (myristylamine), pentadecylamine, hexadecylamine (cetylamine), heptadecylamine, octadecylamine (stearylamine), 4-hexylaniline, 4-heptylaniline, 4-octylaniline, 2,6-diisopropylaniline, 4-ethoxyaniline, N-methylaniline, N-ethylaniline, N-propylaniline, N-butylaniline, N-pentylaniline, N-hexylaniline, N-octylaniline, N-cyclohexylaniline, dicyclohexylamine, p-toluidine, indoline, 2-phenylethylamine, 1-phenylethylamine, N-methyldecylamine, benzylamine, N,N-dimethylbenzylamine, 1-methylimidazole, 2-ethylhexylamine, dibutylamine, dihexylamine, Di-(2-ethylhexylamine), 3,3′-dimethyl-4,4′-diaminodicyclohexylmethane, 4,4′-diaminodicyclohexylmethane, ditridecylamine (isomer mixture), isophoronediamine, N,N,N′,N′-tetramethyl-1,6-hexanediamine, N,N-dimethylcyclohexylamine, octamethylenediamine, 2,6-xylidine, 4,7,10-trioxatridecane-1,13-diamine, 4,9-dioxadodecane-1,12-diamine, Di-(2-methoxyethyl)amine, bis(2-dimethylaminoethyl) ether, Polyetheramin D230® (BASF SE), 2-(diisopropylamino)ethylamine, pentamethyldiethylenetriamine, N-(3-aminopropyl)imidazole, 1,2-dimethylimidazole, 2,2′-dimorpholinodiethyl ether, dimethylaminoethoxyethanol, bis(2-dimethylaminoethyl) ether, Lupragen® N600-s-Triazin (BASF AG), 1,8-diazabicyclo[5.4.0]undec-7-ene (DBU), 3-(2-aminoethylamino)propylamine, 3-(cyclohexylamino)propylamine, dipropylenetriamine, N4-amine (N,N′-bis(3-aminopropyl)-ethylenediamine), AMIX M (BASF AG) (=high-boiling morpholine derivatives), 1-(2-hydroxyethyl)piperazine, 1-vinylimidazole, 1-hexylimidazole, 1-octylimidazole, and 1-(2-ethylhexyl) imidazole.

Preferred amines are those having a boiling point of at least 120° C. at 1013 hPa, more preferably at least 150° C. at 1013 hPa.

The electrolyte preferably comprises 0.5 to 8 parts by weight, more preferably 1 to 5 parts by weight, of amine.

The aprotic solvent is preferably selected from organic carbonates, such as dimethyl carbonate, diethyl carbonate, ethyl methyl carbonate, ethylene carbonate, vinylene carbonate, propylene carbonate, and butylene carbonate; cyclic and linear esters such as methyl acetate, ethyl acetate, butyl acetate, propyl propionate, ethyl butyrate, ethyl isobutyrate; cyclic and linear ethers, 2-methyltetrahydrofuran, 1,2-diethoxymethane, THF, dioxane, 1,3-dioxolane, diisopropyl ether, diethylene glycol dimethyl ether; ketones such as cyclopentanone, diisopropyl ketone, and methyl isobutyl ketone; lactones, such as γ-butyrolactone ; sulfolanes, dimethyl sulfoxide, formamide, dimethylformamide, 3-methyl-1,3-oxazolidin-2-one and mixtures of these solvents. Particularly preferred are the above-described organic carbonates.

The electrolyte preferably comprises 5 to 30 parts by weight, more preferably 10 to 20 parts by weight, of lithium-containing conducting salt.

The lithium-containing conducting salt is preferably selected from LiPF₆, LiBF₄, LiClO₄, LiAsF₆, (LiB(C₂O₄)₂, LiBF₂(C₂O₄)), LiSO₃CₓF₂ₓ₊₁, LiN(SO₂CₓF₂ₓ₊₁)₂ and LiC(SO₂CₓF₂ₓ₊₁)₃ where x adopts integral values from 0 to 8, and mixtures thereof.

The electrolyte preferably comprises 10 to 70 parts by weight, more preferably 20 to 50 parts by weight, and most preferably 12 to 30 parts by weight, of vinylene carbonate (VC).

The electrolytes may, as described in DE10027626A for example, also comprise further additives, such as organic isocyanates to lower the water content, HF scavengers, solubilizers for LiF, organic lithium salts and/or complex salts.

Likewise a subject of the invention is a lithium-ion battery which comprises cathode, anode, separator and the above-described electrolyte.

The negative electrode of the lithium-ion battery (anode) preferably comprises a material which is able reversibly to take on lithium ions and give them up again, such as, for example, metallic lithium, carbon such as carbon black or graphite, silicon, tin, aluminum or lead, preferably graphite and/or silicon. The positive electrode of the lithium-ion battery (cathode) preferably comprises a lithium transition-metal oxide or a lithium transition-metal phosphate. Preferred transition metals are Ti, V, Cr, Mn, Co, Fe, Ni, Mo, W. Preferred lithium transition-metal oxides are LiCoO₂, LiCoO₂, LiNiO₂, LiMnO₂, LiMn₂O₄, Li(CoNi)O₂, Li(CoV)O₂, Li(CoFe)O₂. Preferred lithium transition-metal phosphates are LiCoPO₄, Li(NiMn)O₂ and LiNiPO₄. The electrodes of the lithium-ion battery may comprise further additives, which, for example, raise the conductivity, binders, dispersants and fillers. It is possible to use the further additives which are described in EP785586A.

A further subject of the invention is the use of the above-described electrolyte in a lithium-ion battery.

All above symbols in the above formulae have their definitions in each case independently of one another. In all formulae the silicon atom is tetravalent.

In the examples below, unless indicated otherwise in each case, all quantitative and percentage data are based on weight, all pressures are 0.10 MPa (abs.) and all temperatures at 20° C.

### EXAMPLES

### 1. Reference Electrolyte Mixture with Ethyl Methyl Carbonate (EMC) and Fluoroethylene Carbonate (FEC) (Not Inventive)

Starting from electrolyte compositions known from the literature [Kawashima, A. et al., Journal of The Electrochemical Society 2011, 158, A798-A801; Aurbach, D. et al., Langmuir 2012, 28, 965-976], a mixture was prepared of FEC/EMC in a volume ratio of 30:70. 2 wt % of vinylene carbonate and 1 M LiPF₆ were dissolved in this mixture.

### 2. Electrolyte Mixture with Pentane Nitrile and Tributylamine

A mixture was prepared of vinylene carbonate/diethyl carbonate in a volume ratio of 30:70.

5 wt % of n-pentane nitrile (valeronitrile) and 2 wt % of tributylamine and 1 M LiPF₆ were dissolved in this mixture.

### 3. Electrolyte Mixture with 3-(Fluorodimethylsilyl)Butane-Nitrile and Tributylamine

A mixture was prepared of vinylene carbonate/diethyl carbonate in a volume ratio of 30:70.

10 wt % of fluorodimethylsilylbutanenitrile and 2 wt % of tributylamine and 1 M LiPF₆ were dissolved in this mixture.

### Electrodes and Cell Construction Used

The electrolyte mixtures from examples 1, 2 and 3 were used to construct full cells (of type CR2032) with Si/graphite anode and NMC (nickel manganese cobalt). The quantity of electrolyte was constant at 80 μl. GF Type D Glass Microfiber Filters (Whatman) were used as separator. The anode used consisted 20% of silicon (unaggregated particles having an average particle size of ≠180 nm), 60% of graphite (SFG 6), 8% of binder (CMC 1380) and 12% of conductive carbon black (Super P). The cathode used was a standard material consisting of 94% NMC111, 2% binder and 4% conductive material. The capacity ratio of cathode to anode that was used was 2.0/2.1 mAh/cm². The cells constructed were measured in each case for their discharge capacities in the first cycle, C1, and also for their capacity retention after 100 (retention C100) and 300 (retention C300) cycles. The results are set out in table 1.

### Apparatus and Measurement Methods

Electrochemical testing took place on a BaSyTeC CTS-Lab Battery Test System in full-cell button cells. The cells were first formed in the voltage window of 4.2-3.0 V in two cycles at C/10 and with a subsequent CV step in each case (4.2 V to 3 V, C/10, cccv (cv step to I<0.01 CA)). Subsequently, in the same voltage window, 300 cycles were run at C/2 with a subsequent CV step in each case (4.2 V to 3 V, C/2, cccv (cv step to I<0.125 CA)).

TABLE 1

| | Discharge | Retention | Retention |
|---|---|---|---|
| Electrolyte | capacity C1 | C100 | C300 |
| mixture | [mAh/cm²] | [%] | [%] |
| 1 not | 1.80 | 63.1 | 46.4 |
| inventive | | | |
| 2 with | 1.79 | 79.2 | 69.8 |
| pentane | | | |
| nitrile/ | | | |
| tributylamine | | | |
| 3 with FSN*/ | 1.85 | 80.0 | 69.9 |
| tributylamine | | | |

*FSN: 3-(fluorodimethylsilyl)butanenitrile

The effect of the pentanenitrile/tributylamine and FSN/tributylamine is evident from the capacity retention in table 1: an improvement of around 15% after 100 cycles and an improvement of around 23% after 300 cycles is achieved relative to the reference electrolyte mixture (see example 1).

The same initial state (charging, balancing) of the electrodes with the electrolyte mixtures 1, 2 and 3 is verified by approximately equal discharge capacity of the cells in the first cycle C1.

1.-11. (cancelled)

12. An electrolyte, comprising:
100 parts by weight of at least one aprotic solvent,
1 to 50 parts by weight of at least one lithium-containing conducting salt,
5 to 100 parts by weight of vinylene carbonate,
0.5 to 20 parts by weight of at least one nitrile and
0.1 to 10 parts by weight of at least one amine.

13. The electrolyte of claim 12, wherein at least one nitrile is a nitrile of a monocarboxylic or polycarboxylic acid containing 2 to 20 carbon atoms.

14. The electrolyte of claim 12, which comprises 1 to 10 parts by weight of nitrile.

15. The electrolyte of claim 13, which comprises 1 to 10 parts by weight of nitrile.

16. The electrolyte of claim 12, wherein the amine comprises at least one monoamine of the formula (I)
NR¹R²R³ (I),
in which
R¹, R² and R³ each individually are H or a monovalent hydrocarbyl radical having 1-30 carbon atoms, which may be substituted by F—, Cl— and OR⁴, and wherein nonadjacent —CH₂-units are optionally replaced by units selected from —C(═O)— and —O—, and
R⁴ is C₁₋₁₀ alkyl.

16. The electrolyte of claim 12, wherein at least one amine is a polyamine of the formula (II)
R⁵₂N—(CR⁶₂)ₐ—(NR⁷—(CR⁶₂)_{b})_{c}—NR⁵₂ (II),
in which
R⁵, R⁶ and R⁷ each individually are H or a hydrocarbyl radical having 1-18 carbon atoms, which may be substituted by F—, Cl— and OH—, and wherein nonadjacent —CH₂— units are optionally replaced by units selected from —C(═O)— and —O—,
a and b are integers from 1 to 6, and
c is 0 or an integer from 1 to 40.

17. The electrolyte of claim 12, which comprises 0.5 to 8 parts by weight of amine.

18. The electrolyte of claim 12, which comprises 10 to 70 parts by weight of vinylene carbonate.

19. The electrolyte of claim 12, wherein the at least one aprotic solvent is selected from the group consisting of organic carbonates, cyclic and linear esters, cyclic and linear ethers, ketones, lactones, sulfolanes, dimethyl sulfoxide, formamide, dimethylformamide, 3-methyl-1,3-oxazolidin-2-one and mixtures of these solvents.

20. The electrolyte of claim 12, wherein at least one lithium-containing conducting salt is selected from the group consisting of LiPF₆, LiBF₄, LiClO₄, LiAsF₆, LiSO₃CₓF₂ₓ₊₁, (LiB(C₂O₄)₂, LiBF₂(C₂O₄)), LiN(SO₂CₓF₂ₓ₊₁)₂ and LiC(SO₂CₓF₂ₓ₊₁)₃ where x is an integer from 0 to 8, and mixtures thereof.

21. A lithium-ion battery comprising a cathode, an anode, a separator and an electrolyte of claim 12.

22. The lithium-ion battery of claim 21, wherein the anode comprises a silicon-containing anode.
